(19) United States
(12) Patent Application Publication
(10) Pub. No.: US 2014/0022777 A1
(43) Pub. Date: Jan. 23, 2014

(54) ROTATABLE LAMP ASSEMBLY

(71) Applicant: Shuxian Chen, Shenzhen (CN)

(72) Inventor: Shuxian Chen, Shenzhen (CN)

(73) Assignee: Shenzehn BYD Auto R&D Company Limited, Shenzhen Guangdong (CN)

(21) Appl. No.: 14/008,505

(22) PCT Filed: Apr. 18, 2012
(86) PCT No.: PCT/CN2012/074293

§ 371 Date: Sep. 27, 2013

(30) Foreign Application Priority Data
Apr. 22, 2011 (CN) 201120120654.X

(51) Int. Cl. F21V 19/02

(52) U.S. Cl. CPC F21V 19/02
USPC 362/220

(57) ABSTRACT

A rotatable lamp assembly includes a base having a T-shaped through-hole extended in an axial direction and including a first through hole section having a relatively large diameter and a second through hole section having a relatively small diameter, a luminous tube disposed within the first through hole section; a head rotatably fitted within the second through hole section, and a resisting member disposed onto an inner wall of the first through hole section to resist against an end surface of the head.

### CROSS-REFERENCE TO RELATED APPLICATION

This application claims priority to and benefits of Chinese Patent Application Ser. No. 201120120654.X, filed with the State Intellectual Property Office (SIPO) on Apr. 22, 2011, the entire content of which is incorporated herein by reference.

### FIELD

The present disclosure relates to a lamp assembly, more particularly to a rotatable lamp assembly.

### BACKGROUND

The lamp is common goods, and the LED lamps gradually replace conventional fluorescent lamps and are used widely due to its low energy consuming, high light efficiency and long service life. The irradiation angle of current LED tube is between 180-270 degrees and the irradiation direction may be fixed and limited after the LED tube is installed, so that the irradiation direction of the conventional LED tube can not be adjusted and inconvenient for users.

### SUMMARY

Embodiments of the present disclosure seek to solve at least one of the problems existing in the prior art to at least some extent, or to provide a consumer with a useful commercial choice.

Accordingly, there is provided a rotatable lamp assembly, comprising: a base having a T-shaped through-hole which is extended in an axial direction and including a first through hole section having relatively large diameter and a second through hole section having a relatively small diameter; a luminous tube disposed within the first through hole section; a head having a connection part rotatably fitted within the second through hole section, a rotary groove formed in an end surface of the connection part and a locking part disposed onto an outer circumferential surface of the connection part; and a resisting member disposed onto an inner wall of the first through hole section to resisting against the end surface of the connection part, and adapted to be received in the rotary groove and rotate along and relative to the end surface of the connection part, in which a gap is formed between the resisting member and the second through hole section, and the locking part is caught within the gap.

With the rotatable lamp assembly according to an embodiment of the present disclosure, when the head is fitted within the base, the locking part is caught within the gap formed by the resisting member and the second through hole section, thus the head and the base may not be separated from each other in the radial direction and the axial direction , and when the resisting member is located in a rotary groove and rotate along the end surface of the connection part, the luminous tube may be rotated with the base, thus the irradiation direction may be adjusted according to user's demand and it is convenient for use.

Additional aspects and advantages of the embodiments of present disclosure will be given in part in the following descriptions, become apparent in part from the following descriptions, or be learned from the practice of the embodiments of the present disclosure.

### BRIEF DESCRIPTION OF THE DRAWINGS

The foregoing and other features and advantages of the disclosure will become apparent and more readily appreciated from the following descriptions taken in conjunction with the drawings in which:

FIG. 1 is an explosive view of the rotatable lamp assembly according to an embodiment of the present disclosure;

FIG. 2 is a structural view of a head of the rotatable lamp assembly according to an embodiment of the present disclosure; and

FIG. 3 is a structural view of a base of the rotatable lamp assembly according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the description, relative terms such as “longitudinal”, “lateral”, “front”, “rear”, “right”, “left”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

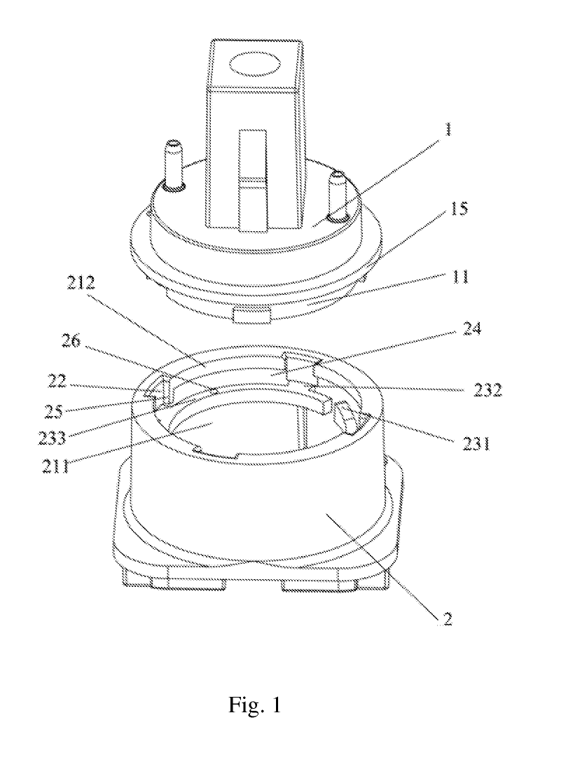

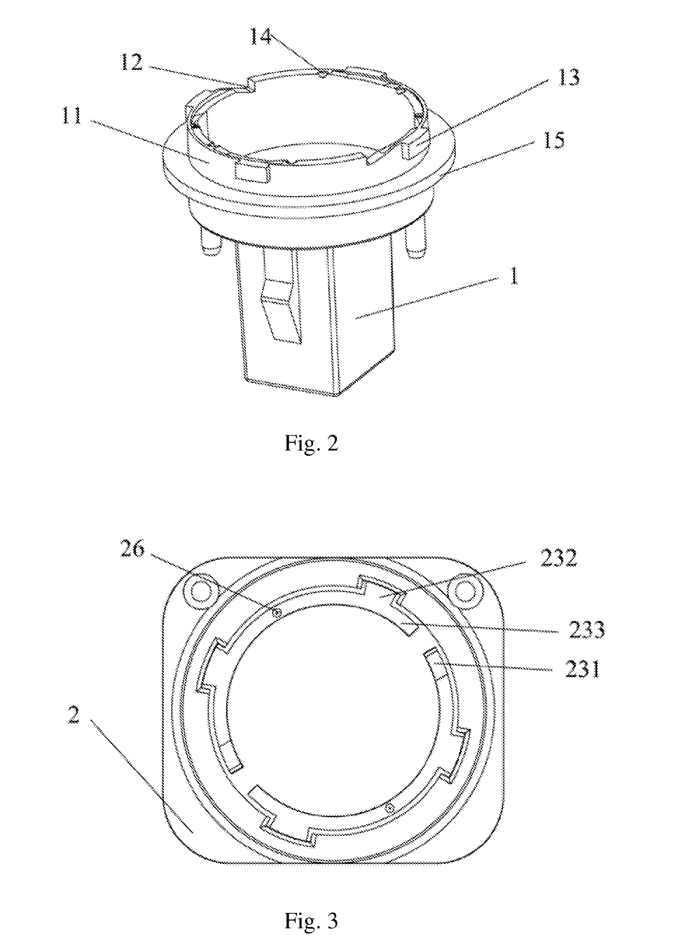

As shown in FIGS. 1 to 3, the rotatable lamp assembly according to an embodiment of the present disclosure will be described below. The rotatable lamp assembly may comprise a base 2 having T-shaped through-hole extended in an axial direction thereof, a head 1 and a luminous tube (not shown) and a resisting member. Here “rotatable” means that the base 1 is rotatable relative to the head 1.

The T-shaped through-hole has a first through hole section 211 with relative large diameter and a second through hole section 212 with relative small diameter. The head 1 has a connection part 11, a rotary groove 12 formed in an end surface of the connection part 11 and a locking part 13 disposed onto an outer circumferential surface of the connection part 11. The connection part 11 is rotatably fitted within the second through hole section 212, that is, the second through hole section 212 is fitted over the connection part 11.

The luminous tube is disposed within the first through hole section 211. The resisting member is disposed onto an inner wall of the first through hole section 211 to resisting against the end surface of the connection part 11. The resisting member is adapted to be received in the rotary groove 12 and rotate along and relative to the end surface of the connection part 11. A gap 24 is formed between the resisting member and the second through hole section 212, and the locking part 13 is caught within the gap 24.

In some embodiments, the rotatable lamp assembly is formed by assembling the head 1 and the base 2. The T-shaped through-hole may comprise two through holes (i.e. two through hole sections) communicated with each other, in which one hole has a relative larger diameter and the other hole has a relative smaller diameter, such that the through hole has a cross-section of T-shape and can be referred to T-shaped through hole.

With the rotatable lamp assembly according to an embodiment of the present disclosure, when the head 1 is assembled with the base 2, the locking part 13 is caught and located between the resisting member and the second through hole section 211, so that the head 1 and the base 2 may not be separated from each other in the radial direction, and when the resisting member is received in the rotary groove 12 and rotate along and relative to the end surface of the connection part 11, the luminous tube may be rotated with the base 2, thus the irradiation direction may be adjusted according to user's demand and it is convenient for use.

Furthermore, the locking part 13 may be a shrinkable boss which is shrinkable in a radial direction thereof. When the second through hole section 212 is fitted over the connection part 11, the inner wall of the second through hole section 212 may squeeze the shrinkable boss and the shrinkable boss may be shrunk so that the outer circumferential surface of the second through hole section 212 will be flush with the outer circumferential surface of the connection part 11, thus the second through hole section 212 may be fitted over the connection part 11, and the head 1 may be kept on moving in the axial direction until the inner wall of the second through hole section 212 does not squeeze the shrinkable boss, the shrinkable boss may be expanded and the outer circumferential surface of the shrinkable boss may exceed the inner wall of the second through hole section 212 in the radial direction. The shrinkable boss may be located and caught in the gap 24 formed by the resisting member and the second through hole section 212. Therefore, the head 1 and the base 2 may not be separated from each other in the radial direction and the axial direction.

In some embodiments, the locking part 13 may be a rigid boss extended outwardly from the outer circumferential surface of the connection part 11, and the base 2 may further comprise a positioning groove 22 formed in the inner wall of the second through hole section 212 extended through the inner wall of the second through hole section 212 in the axial direction. The rigid boss may be received in the positioning groove 22 and may be able to move along the positioning groove 22. After the base 2 is fitted over the head 1, because the positioning groove 22 is formed and extended through the second through hole section 212 in the axial direction, when the base 2 is rotated, the rigid boss may be escaped from the positioning groove 22, that is, the rigid boss is escaped from the second through hole section 212, and the rigid boss enters and is caught in the gap 24, thus preventing the head 1 from separating from the base 2. In some embodiments, four positioning grooves may be formed in the inner wall of the second through hole section 212 in order to facilitating the connection between the head 1 and the second through hole section 212. Alternatively, the number of the rigid boss formed in the outer circumferential surface of the connection part 11 may be one, two, or three, it is preferable that four rigid bosses are disposed so as to facilitate assembling and securing of the head 1 and the base 2.

In some embodiments, the resisting member comprises a circular part disposed onto the inner wall of the first through hole section 211 and extended in the radial direction; and a protruded part 231 disposed on an end surface the circular part adjacent to the second through hole section 212 and configured to resist against the end surface of the connection part 11, the circular part has a diameter smaller than that of the second through hole section 212, such that when the second through hole section 212 is fitted over the connection part 11, the circular part may contact and resist against the end surface of free end of the second through hole section 212. The diameter of the circular part may be the same as that of the second through hole section 212, so that the circular part may be able to contact and resist against the end surface of free end of the second through hole section 212.

Furthermore, in order to facilitate the resisting member to elastically deform, the resisting member further comprises a coupling part 232 disposed and connected between the circular part and the inner wall of the first through hole section 211. The coupling part 232 and the circular part are in the same level, thus the coupling part 232 and the rigid boss may not be interfered with each other when the head 1 and the base are assembled with each other, so that the rigid boss may be moved into the gap 24 formed by the resisting member and the second through hole section 212 with the rotation of the base 2.

Furthermore, the circular part may be formed with two notches so as to be formed as two arc parts 233, and the arc lengths of the two arc parts 233 may be the same. In some embodiments, a protruded part 231 may be disposed on each arc part 233 and two rotary grooves 12 may be formed in the end surface of the connection part 11. When one protruded part 231 is moved and received in one corresponding rotary groove 12, the other protruded part 231 may also be moved and received in the other rotary groove 12. When the rigid boss is moved into the gap 24 formed by the resisting member and the second through hole section 212 with the rotation of the base 2, the protruded part 231 will be moved into the rotary groove 12 with the further rotation of the base, thus accomplishing the assembling of the base 2 and the head 1.

Furthermore, in order to prevent the wires of the lamp assembly be broken due to rotation between the head 1 and the base 2, the base 2 further comprises a blocking part 25 disposed onto the inner wall of the first through hole section 211 for limiting a relative rotation between the base 2 and the head 1. When the rigid boss is moved out from the positioning groove 22, the base 2 may be needed to rotate to move the protruded part 231 into the rotary groove 12. For example, by rotating the base 2 in a first direction or a second direction, the protruded part 231 may be moved into the rotary groove 12. When the rotation angle in the first direction may be 170 degrees, or the rotation angle in the second direction may be 10 degrees, the blocking part 25 may stop the relative rotation between the base 2 and the head 1. When the base 2 is rotated in the first direction, one of the four rigid boss may be blocked by the blocking part 25 to limit the further movement of the base 2 in the first direction, thus simplifying the assembling of the base 2 and the head 1. If the head 1 and the base 2 can be rotated with each other without limitation, the wires may be twisted and broken. When the base 2 is rotated in the first direction, one of the four rigid bosses may be blocked by the blocking part 25 and the base 2 may be rotated in the second direction. But when the base 2 and head 1 rotate relative each other by a certain degree, another one of the four bosses may be blocked by the blocking part 25, thus further movement between the base 2 and head 1 may be limited so as to prevent the base 2 and head 1 from over rotating and avoid breaking of the wires.

Furthermore and in some embodiments, the rotatable lamp assembly may further comprise a recess 14 formed in the end surface of the connection part and a protrusion 26 disposed on the end surface of the circular part adjacent the second through hole section 212 and configured to be fitted within the recess 14. When the head 1 and the base 2 are rotated relatively to a predetermined degree, the protrusion 26 may be moved into the recess 14, thus the base 2 and the head 1 may be in a stable state in such a position at which the recess 14 and the protrusion 26 are slightly locked in the position.

In some embodiments, the head 1 may comprise a positioning part 15 disposed onto the outer circumferential surface of the connection part 11. The positioning part 15 contacts and resists against the end surface of free end of the second through hole section 212 when the resisting member contacts and resists against the end surface of the connection part 11. The second through hole section 212 have two ends; one end is connected with the first through hole section 211 and the other end is the free end. When the end surface of the connection part 11 contact and resist against the protruded part 231, the positioning part 15 may prevent further movement between the base 2 and the head 1, so that the end surface of the connection part 11 is prevented from applying force to the resisting member, thus avoiding destroying of the resisting member due to over-deforming.

The structure and assemble process of the lamp assembly will be described below: firstly the four rigid bosses on the head 1 are aligned with four positioning grooves 22 of the base 2, then the four rigid bosses are moved into the four positioning grooves 22 respectively, and the head 1 and base 2 are moved relative to each other until the protruded part 231 of the base 2 contact and resist against the end surface of the connection part 11, the head 1 and the base 2 may be kept to relatively move with each other until the protruded part 231 of the base 2 is flush with the circular part and the coupling part 232 due to squeezing of the end surface of connection part 11. Then the head 1 or the base 2 may be further rotated such that the protruded part 231 is moved into the recess 14, and the rigid boss may be moved and caught in the gap 24 formed by the resisting member and the second through hole section 212, thus the assemble process may be completed.

Reference throughout this specification to “an embodiment”, “some embodiments”, “some embodiments”, “an example”, “a specific examples”, or “some examples” means that a particular feature, structure, material, or characteristic described in connection with the embodiment or example is included in at least some embodiments or example of the disclosure. Thus, the appearances of the phrases such as “in some embodiments”, “in some embodiments”, “in an embodiment”, “an example”, “a specific examples”, or “some examples” in various places throughout this specification are not necessarily referring to the same embodiment or example of the disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, and modifications may be made in the embodiments without departing from spirit and principles of the disclosure. Such changes, alternatives, and modifications all fall into the scope of the claims and their equivalents.

1. A rotatable lamp assembly, comprising:
a base having a T-shaped through-hole which is extended in an axial direction and including a first through hole section having relatively large diameter and a second through hole section having a relatively small diameter;
a luminous tube disposed within the first through hole section;
a head having a connection part rotatably fitted within the second through hole section, a rotary groove formed in an end surface of the connection part and a locking part disposed onto an outer circumferential surface of the connection part; and
a resisting member disposed onto an inner wall of the first through hole section to resist against the end surface of the connection part, and adapted to be received in the rotary groove and rotate along and relative to the end surface of the connection part, in which a gap is formed between the resisting member and the second through hole section, and the locking part is caught within the gap.

2. The rotatable lamp assembly of claim 1, wherein the locking part includes a shrinkable boss which is shrinkable in a radial direction thereof.

3. The rotatable lamp assembly of claim 1, wherein the locking part includes a rigid boss extended outwardly from the outer circumferential surface of the connection part, and
wherein the base further comprises a positioning groove formed in the inner wall of the second through hole section and extended through the inner wall of the second through hole section in the axial direction, and the rigid boss is adapted to be received in the positioning groove.

4. The rotatable lamp assembly of claim 3, wherein the base further comprises a blocking part disposed onto the inner wall of the first through hole section for limiting a relative rotation between the base and the head.

5. The rotatable lamp assembly of claim 3, wherein the resisting member comprises:
a circular part disposed onto the inner wall of the first through hole section and having a diameter smaller than that of the second through hole section; and
a protruded part disposed on an end surface the circular part adjacent to the second through hole section, and configured to resist against the end surface of the connection part.

6. The rotatable lamp assembly of claim 5, wherein the resisting member further comprises a coupling part disposed between the circular part and the inner wall of the first through hole section, extended in a radial direction and being in the same level with the circular part.

7. The rotatable lamp assembly of claim 6, wherein the circular part is formed with two notches so as to be formed as two arc parts.

8. The rotatable lamp assembly of claim 7, wherein arc lengths of the two arc parts are identical.

9. The rotatable lamp assembly of claim 5, further comprising:
a recess formed in the end surface of the connection part, and
a protrusion disposed on the end surface of the circular part and configured to be fitted within the recess.

10. The rotatable lamp assembly of claim 1, wherein the head comprises a positioning part disposed onto the outer circumferential surface of the connection part, and configured to resist against the end surface of a free end of the second through hole section when the resisting member contacts and resists against the end surface of the connection part.

11. A rotatable lamp assembly, comprising:
a base having a through-hole extending in an axial direction and including a first through hole section having relatively large diameter and a second through hole section having a relatively small diameter;
a light disposed within the first through hole section;
a head rotatably fitted within the second through hole section; and
a resisting member disposed in the first through hole section to resist against an end surface of the head.

12. The rotatable lamp assembly of claim of claim 11, wherein the head includes a locking part disposed on an outer circumferential surface of the head, and the locking part is a shrinkable boss which is shrinkable in a radial direction thereof.

13. The rotatable lamp assembly of claim of claim 11, wherein the head includes a locking par, which is a rigid boss, disposed on an outer circumferential surface of the head, and the base includes a positioning groove for receiving the rigid boss.
